(19) United States
(12) Patent Application Publication
(10) Pub. No.: US 2026/0343449 A1
(43) Pub. Date: Oct. 29, 2026

(54) LOW LATENCY TIMING ADVANCE COMMAND INDICATION IN LAYER 1 / LAYER 2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/099,696

(22) PCT Filed: Sep. 30, 2022
(86) PCT No.: PCT/CN2022/123065

§ 371 Date: Jan. 29, 2025

(51) Int. Cl. H04W 56/00; H04W 72/232; H04W 74/0833

(52) U.S. Cl. CPC H04W 56/0045; H04W 72/232; H04W 74/0833

(57) ABSTRACT

A network entity transmits a command triggering a timing advance (TA) update associated with one or more TA groups (TAGs) associated with a candidate special cell (spCell) or a candidate cell group (CG) and receives data responsive to the command; or the network entity transmits a downlink control information (DCI) including a first TA value and receives an uplink slot having a time of arrival adjusted by the first TA value. A user equipment (UE) receives a command to trigger a TA update associated with one or more TAGS associated with a candidate spCell or a candidate CG and transmits at least one of a reference signal or data in response to receiving the command; or the UE receives a DCI including a first TA value and transmits an uplink slot having a time of transmission adjusted by the first TA value.

### TECHNICAL FIELD

The technology discussed below relates generally to wireless communication systems and, more particularly, to low latency timing advance command (TAC) indication in Layer 1/Layer 2 mobility (L1/L2 mobility).

### INTRODUCTION

A user equipment (UE) may be located at different distances from a plurality of network entities (e.g., base stations, gNBs, radio units associated with a distributed unit) at any given time. The network entities may be associated with various primary cells (PCells), secondary cells (SCells), primary secondary cells (PSCells) and special cells (spCells) that serve, or may serve, the UE. Because the distances vary, the propagation delay (which is proportional to distance) between the network entities and the UE correspondingly varies. The variation in propagation delay causes uplink transmissions from the UE to arrive at the network entities at different times. Timing advance may be used to control an uplink transmission timing of a UE.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a network entity is disclosed. The network entity includes a memory, and a processor coupled to the memory. In the example, the processor is configured to: transmit a command to trigger a timing advance (TA) update associated with one or more timing advance groups (TAGs) associated with at least one of: a candidate special cell (spCell), or a candidate cell group (CG), and receive data responsive to the command.

In another example, a method operation at a network entity is disclosed. The method includes transmitting a command to trigger a timing advance (TA) update associated with one or more timing advance groups (TAGs) associated with at least one of: a candidate special cell (spCell), or a candidate cell group (CG), and receiving data responsive to the command.

In another example, an apparatus is disclosed. The apparatus, which may be a network entity, includes means for transmitting a command to trigger a timing advance (TA) update associated with one or more timing advance groups (TAGs) associated with at least one of: a candidate special cell (spCell), or a candidate cell group (CG), and means for receiving data responsive to the command.

In another example, a non-transitory computer-readable medium storing computer-executable code is disclosed. The code may cause an apparatus, such as a network entity, to transmit a command to trigger a timing advance (TA) update associated with one or more timing advance groups (TAGs) associated with at least one of: a candidate special cell (spCell), or a candidate cell group (CG), and receive data responsive to the command.

In one example, a network entity is disclosed. The network entity includes a memory, and a processor coupled to the memory. In the example, the processor is configured to transmit a downlink control information (DCI) including a first timing advance (TA) value and receive an uplink slot having a time of arrival adjusted by the first TA value.

In another example, a method operation at a network entity is disclosed. The method includes transmitting a downlink control information (DCI) including a first timing advance (TA) value and receiving an uplink slot having a time of arrival adjusted by the first TA value.

In another example, an apparatus is disclosed. The apparatus, which may be a network entity, includes means for transmitting a downlink control information (DCI) including a first timing advance (TA) value, and means for receiving an uplink slot having a time of arrival adjusted by the first TA value.

In another example, a non-transitory computer-readable medium storing computer-executable code is disclosed. The code may cause an apparatus, such as a network entity, to transmit a downlink control information (DCI) including a first timing advance (TA) value and receive an uplink slot having a time of arrival adjusted by the first TA value.

In one example, a user equipment is disclosed. The user equipment includes a memory, and a processor coupled to the memory. In the example, the processor is configured to: receive a command to trigger a timing advance (TA) update associated with one or more timing advance groups (TAGs) associated with at least one of: a candidate special cell (spCell), or a candidate cell group (CG), and transmit at least one of a reference signal or data in response to receiving the command.

In another example, a method operation at a user equipment is disclosed. The method includes receiving a command to trigger a timing advance (TA) update associated with one or more timing advance groups (TAGs) associated with at least one of: a candidate special cell (spCell), or a candidate cell group (CG); and transmitting at least one of a reference signal or data in response to receiving the command.

In another example, an apparatus is disclosed. The apparatus, which may be a user equipment, includes means for receiving a command to trigger a timing advance (TA) update associated with one or more timing advance groups (TAGs) associated with at least one of: a candidate special cell (spCell), or a candidate cell group (CG); and means for transmitting at least one of a reference signal or data in response to receiving the command.

In another example, a non-transitory computer-readable medium storing computer-executable code is disclosed. The code may cause an apparatus, such as a user equipment, to receive a command to trigger a timing advance (TA) update associated with one or more timing advance groups (TAGs) associated with at least one of: a candidate special cell (spCell), or a candidate cell group (CG). and transmit at least one of a reference signal or data in response to receiving the command.

In one example, user equipment is disclosed. The user equipment includes a memory, and a processor coupled to the memory. In the example, the processor is configured to receive a downlink control information (DCI) including a first timing advance (TA) value and transmit an uplink slot having a time of transmission adjusted by the first TA value.

In another example, a method operation at a user equipment is disclosed. The method includes receiving a downlink control information (DCI) including a first timing advance (TA) value and transmitting an uplink slot having a time of transmission adjusted by the first TA value.

In another example, an apparatus is disclosed. The apparatus, which may be a user equipment, includes means for receiving a downlink control information (DCI) including a first timing advance (TA) value, and means for transmitting an uplink slot having a time of transmission adjusted by the first TA value.

In another example, a non-transitory computer-readable medium storing computer-executable code is disclosed. The code may cause an apparatus, such as a user equipment, to receive a downlink control information (DCI) including a first timing advance (TA) value and transmit an uplink slot having a time of transmission adjusted by the first TA value.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is an expanded view of an exemplary subframe, showing an orthogonal frequency divisional multiplexing (OFDM) resource grid according to some aspects of the disclosure.

FIG. 4 is a diagram providing a high-level illustration of one example of a configuration of a disaggregated base station according to some aspects of the disclosure.

FIG. 5 is a block diagram illustrating protocol stacks that may be implemented in a user plane and a control plane of various wireless communication devices, such as the various wireless communication devices shown and described above in connection with the examples of FIGS. 1, 2, and/or 4 according to some aspects of the disclosure.

FIGS. 6A and 6B are schematic diagrams illustrating aspects of timing advance according to some aspects of the disclosure.

FIG. 7 is a schematic diagram illustrating reselection or updating of an spCell among a set of pre-configured candidate spCells based on a user equipment's L1 measurement of those cells according to some aspects of the disclosure.

FIG. 8 is a block diagram illustrating an example of a hardware implementation of a network entity employing a processing system according to some aspects of the disclosure.

FIG. 9 is a flow chart illustrating an exemplary process at a network entity according to some aspects of the disclosure.

FIG. 10 is a flow chart illustrating an exemplary process at a network entity according to some aspects of the disclosure.

FIG. 11 is a block diagram illustrating an example of a hardware implementation of a user equipment employing a processing system according to some aspects of the disclosure.

FIG. 12 is a flow chart illustrating an exemplary process at a user equipment according to some aspects of the disclosure.

FIG. 13 is a flow chart illustrating an exemplary process at a user equipment according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

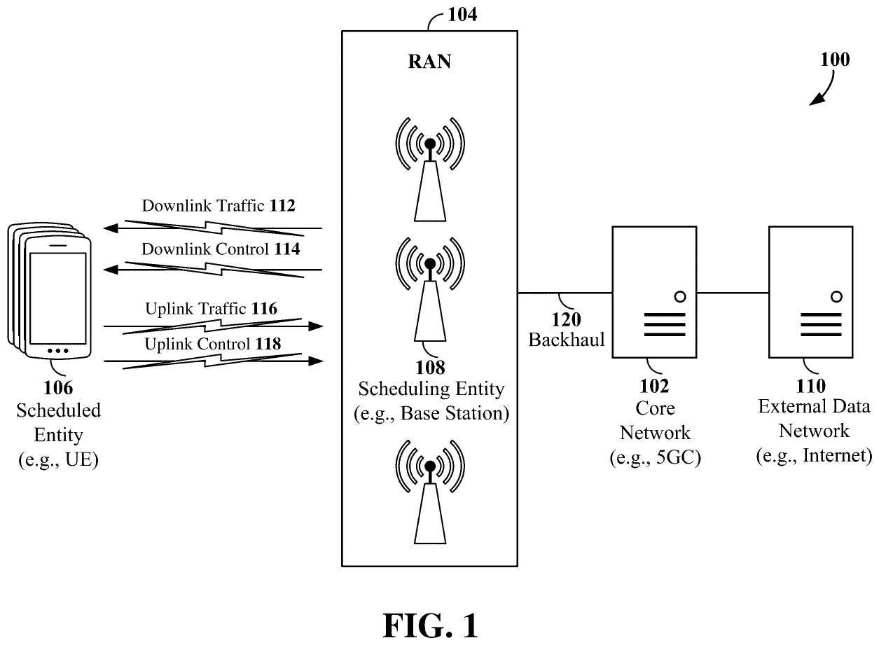

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108 Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control 114, including but not limited to scheduling information (e.g., a grant), synchronization or timing information, or other control information from another entity in the wireless communication network such as the scheduling entity 108. The scheduled entity 106 may further transmit uplink control 118, including but not limited to a scheduling request or feedback information, or other control information to the scheduling entity 108.

In addition, the uplink control 118 and/or downlink control 114 information and/or the uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

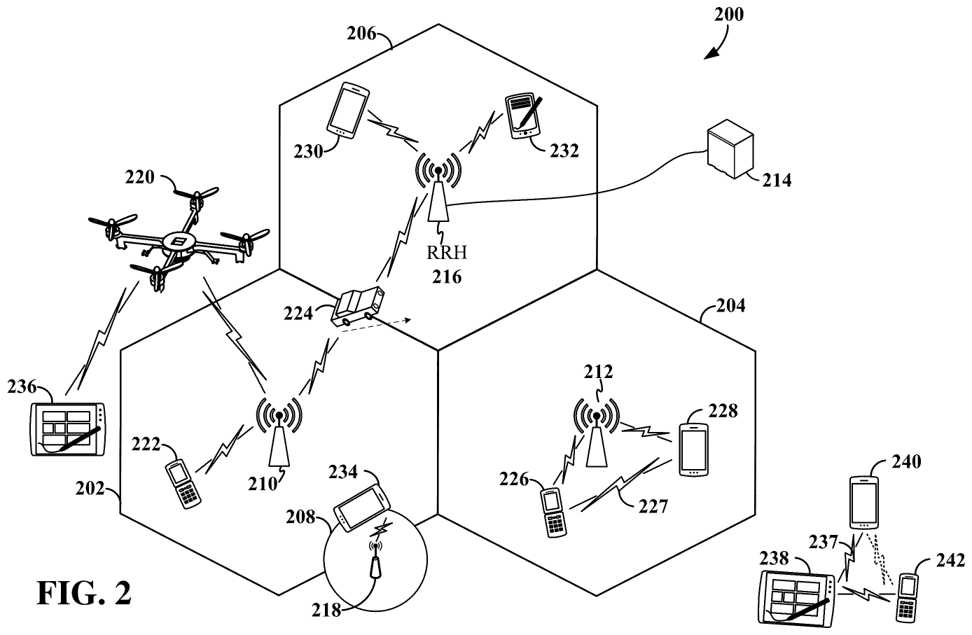

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate the sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints Qualcomm can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full-duplex (SBFD), also known as flexible duplex.

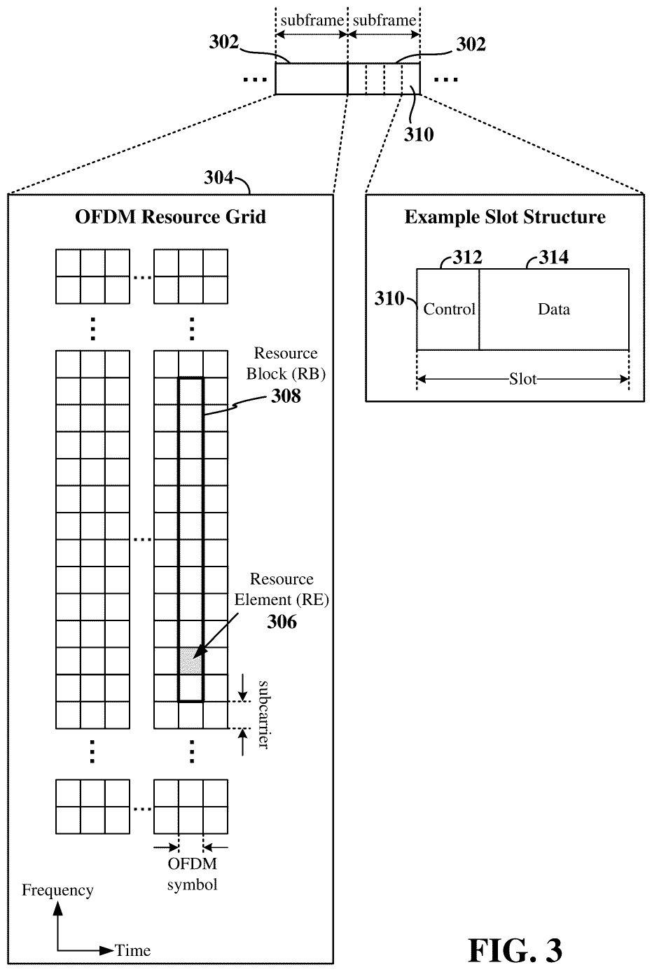

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

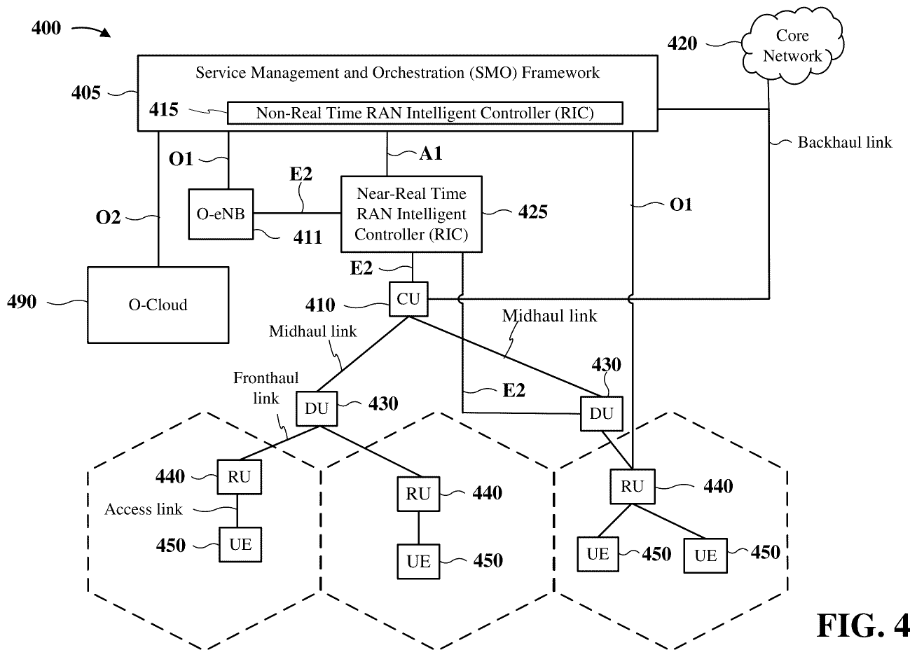

FIG. 4 is a diagram providing a high-level illustration of one example of a configuration of a disaggregated base station 400 according to some aspects of the disclosure. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUS) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUS 410, the DUs 430, the RUs 440, as well as the Near-RT RIC 425, the Non-RT RIC 415, and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RIC 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

User equipment uplink transmissions may be synchronized with downlink transmissions to ensure that a start of an uplink frame from a plurality of user equipment is received at a network entity at a same time. To compensate for the varying distances between the network entity and individual ones of the plurality of user equipment, timing advance commands are sent from the network entity to the UEs. A UE may utilize timing advance groups (TAGs) and associated time alignment timers to set the start of uplink frames and then monitor the degree of synchronization of the uplink frames with downlink frames. Adding to the complexity are the identities and roles of various cells, such as the primary cell (PCell), the secondary cell (SCell), the primary secondary cell (PSCell), and the special cell (spCell) (which corresponds to a PCell+PSCell). Additionally, a set of serving cells controlled by one network entity may be referred to as a cell group (CG). A master cell group (MCG) may be that set of serving cells controlled by a network entity that controls a PCell. A secondary cell groups (SCG) may describe a set of serving cells controlled by a network entity that is not associated with the MCG. Members of a timing advance group (TAG) share the same timing. TAGs may be identified as primary-timing advance groups (P-TAGs) or secondary-timing advance groups (S-TAGs).

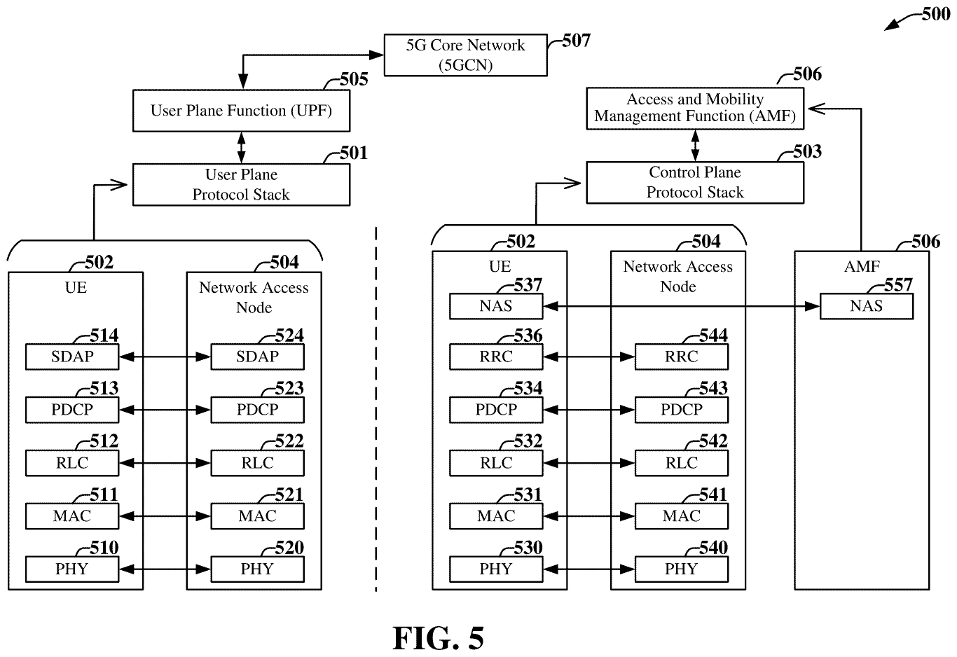

FIG. 5 is a block diagram illustrating protocol stacks 500 that may be implemented in a user plane and a control plane of various wireless communication devices (e.g., UEs, base stations, gNBs, RUs, DUs, OeNBs, etc.), such as the various wireless communication devices shown and described above in connection with the examples of FIGS. 1, 2, and/or 4. The protocol stacks 500 are illustrated as being implemented in a user equipment (UE) 502 (e.g., a client device), a network access node 504 (e.g., a gNB, a base station, a network entity), and an access and mobility management function (AMF) 506. The user plane protocol stack 501 implemented at the UE 502 may include a Physical (PHY) 510 layer, a Medium Access Control (MAC) 511 layer, a Radio Link Control (RLC) 512 layer, a Packet Data Convergence Protocol (PDCP) 513 layer, and a Service Data Adaptation Protocol (SDAP) 514 layer. The user plane protocol stack 501 implemented at the network access node 504 corresponds to the protocol stack implemented at the UE 502. Accordingly, the user plane protocol stack 501 implemented at the network access node 504 may include a Physical (PHY) 520 layer, a Medium Access Control (MAC) 521 layer, a Radio Link Control (RLC) 522 layer, a Packet Data Convergence Protocol (PDCP) 523 layer, and a Service Data Adaptation Protocol (SDAP) 524 layer. In accordance with an open systems interconnection (OSI) model, the PHY layer 510 and PHY layer 520 may be referred to as a first layer or an L1 layer. The MAC 511, 521, RLC 512, 522, PDCP 513, 523, and SDAP 514, 524 layers may be referred to as a second layer or an L2 layer. User data (e.g., similar to downlink traffic 112 and uplink traffic 116 of FIG. 1) in each of the identified layers may be conveyed over an air interface (not shown) between the PHY 510 layer of the UE 502 and the PHY 520 layer of the network access node 504.

The control plane protocol stack 503 implemented at the UE 502 may include a PHY 530 layer, a MAC 531 layer, an RLC 532 layer, a PDCP 533 layer, a Radio Resource Control (RRC) 536 layer, and a non-access stratum (NAS) 537 layer. The control plane protocol stack 503 implemented at the network access node 504 corresponds to the protocol stack implemented at the UE 502 except for a NAS 537 layer. The NAS 537 layer passes through the network access node 504 but does not terminate at the network access node 504. Instead, the NAS 537 layer at the UE 502 terminates at a corresponding NAS 257 layer of the AMF 506. Based on the network access node 504 correspondence to the protocol stack implemented at the UE 502, the control plane protocol stack 503 implemented at the network access node 504 may include a PHY 540 layer, a MAC 541 layer, an RLC 542 layer, a PDCP 543 layer, and an RRC 544 layer. Control signaling messaging (e.g., similar to downlink control 114 and uplink control 118 of FIG. 1) in each of the identified layers may be conveyed over the air interface (not shown) between the PHY 530 layer of the UE 502 and the PHY 540 layer of the network access node 504.

A user plane function (UPF) 505 interfaces with the entities of the user plane protocol stack 501 and may be at least one of a function or circuit that at least one of functionally or operationally couples the user data conveyed over the user plane to a 5G core network (5GCN) 207. The UPF 505 may provide an interconnect point between the mobile infrastructure (e.g., network access nodes, TRPs, etc.) and a data network (not shown) such as the Internet. The AMF 506 may serve as the interface between the NAS 537, 557 entities in the control plane protocol stack 503. The AMF 506 may support, for example, the termination of NAS signaling, NAS ciphering & integrity protection, registration management, connection management, mobility management, access authentication and authorization, and security context management. Detailed explanations of just-identified user plane and control plane entities are available to those of skill in the art and will not be described herein for conciseness.

The channels or carriers illustrated in FIGS. 1, 2, 3, 4, and/or 5 are not necessarily all of the channels or carriers that may be utilized between devices, and those of ordinary skill in the art will recognize that other channels or carriers may be utilized in addition to those illustrated, such as other traffic, control, and feedback channels.

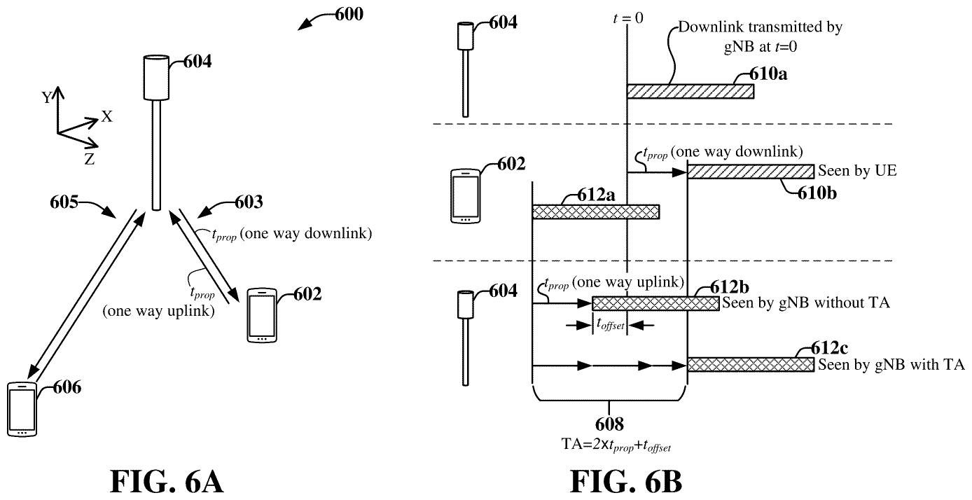

FIGS. 6A and 6B are schematic diagrams illustrating aspects of timing advance according to some aspects of the disclosure. FIG. 6A depicts a first UE 602 (e.g., a wireless communication device) and a second UE 606 at different distances from a network entity 604 (e.g., a gNB, a base station, etc.). The first UE 602 is closer to the network entity 604 than the second UE 606 in the X-Z plane of FIG. 6A.

FIG. 6B depicts the network entity 604 and the first UE 602 at several instances in time and graphically represents downlink and uplink frames at those several instances in time. FIG. 6B illustrates timing advance in the context of propagation delay and timing offset from the perspectives of the network entity 604 and the first UE 602.

Timing Advance (TA) may be executed by use of a command (i.e., a Timing Advance Command (TAC)) sent by the network entity 604 to the first UE 602. The TAC causes the first UE 602 to adjust the timing of its uplink transmission. In practice, the implementation of TA may cause the first UE 602 to send uplink symbols in advance of a time that the UE would transmit the uplink symbols without TA. The uplink transmissions may be, for example, at least one of PUSCH, PUCCH, and SRS transmissions. The TAC informs the first UE 602 of the amount of time that the UE needs to advance the UE's uplink transmissions.

The TAC may have at least two variants. The first variant may be referred to as an initial TAC. The initial TAC may be sent via a random access response (RAR) message, transmitted from the network entity 604 to the first UE 602. The RAR may be a response to a random access preamble transmitted from the first UE 602 to the network entity 604.

The second variant may convey a TAC via a medium access control-control element (MAC-CE). According to some aspects, timing advance may be controlled by a MAC entity (e.g., controlled at the MAC layer) and may be implemented by the physical layer.

By way of example and not limitation, an initial TAC may be conveyed via RAR and may set a first TA. When the TA of the UE (e.g., first UE 602) needs to be corrected, a given network entity 604 (e.g., gNB, base station, etc.) may send a TAC to the first UE 602, commanding the first UE 602 to adjust the uplink transmission timing. The TAC may be sent to the first UE 602 via a TAC MAC-CE. Therefore, timing advance may be implanted by a MAC entity of a UE, such as, for example, the MAC 511 entity of the UE 502 of FIG. 5. The TAC MAC-CE may have a fixed 8 bits, of which the first two bits represent a TAG identity (TAG ID), and the final 6 bits represent the TAC. The TAG ID indicates the Timing Advance Group Identity. The TAG containing a spCell has the TAG Identity of 0. The TAC field indicates the index value TA (0, 1, 2, . . . 63) used to control the amount of timing adjustment that the MAC entity (e.g., similar to the MAC 531 layer or entity as shown and described in connection with FIG. 5) is commanded to apply. The first UE 602 may determine the degree of uplink synchronization at the MAC layer based on a timer referred to herein as a timeAlignmentTimer. The timeAlignmentTimer is provided to the UE via RRC signaling (e.g., via an RRC entity, similar to the RRC entity 536 as shown and described in connection with FIG. 5).

Additional mechanisms to transport timing advance values from the network entity 604 to the first UE 602 may be described herein.

The timing advance value may depend on the signal propagation delay between the network entity 604 and the first UE 602. Accordingly, different UEs located at various locations will have different timing advance values. The goal of the TAC is to align the uplink transmission from all UEs to a network entity.

In the example of FIG. 6A, the first UE 602 is closer to the network entity 604 than a second UE 606. Accordingly, uplink and downlink transmissions of the first UE 602 (represented by the directions of a first set of arrows 603) will have a shorter (e.g., less elapsed time) propagation delay (tprop) than the uplink and downlink transmissions of the second UE 606 (represented by the directions of a second set of arrows 605). The physical distances, and therefore the temporal propagation delays, between the network entity 604 and the first UE 602 and between the network entity 604 and the second UE 606 are represented by the lengths of the first set of arrows 603 and the lengths of the second set of arrows 605, respectively. Accordingly, when making timing adjustments, the first UE 602 may utilize a smaller (e.g., shorter) timing advance than the second UE 606.

Turning now to FIG. 6B, according to some aspects, an uplink frame 612a, having a given frame number (not shown), used for uplink transmission from the first UE 602, may start a given amount of time (i.e., TA microseconds) before a beginning of a corresponding downlink frame 610b as received at the first UE 602. The given amount of time may be referred to as the timing advance (TA). By starting the uplink frame 612a by TA microseconds before the beginning of the reception of the downlink frame 610b at the first UE 602, the starting edges of the downlink frame 610b (as seen at the first UE 602) and the uplink frame 612c (as seen by the network entity 604) may be caused to coincide, or substantially coincide.

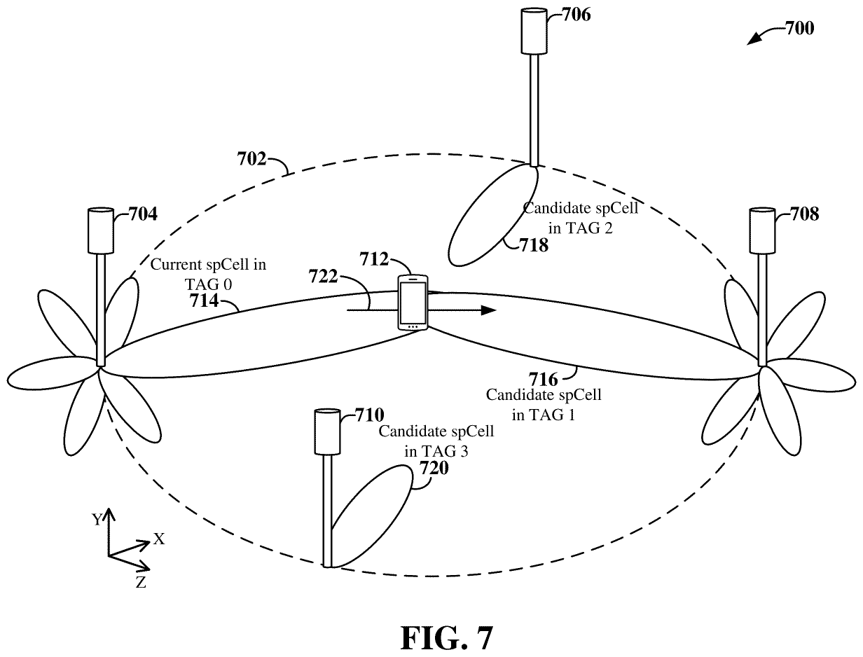

FIG. 7 is a schematic diagram illustrating a pre-configured candidate spCell set 700 according to some aspects of the disclosure. The pre-configured candidate spCell set 700 is associated with four network entities: a first network entity 704, a second network entity 706, a third network entity 708, and a fourth network entity 710. The network entity may be implemented in an aggregated or monolithic base station architecture (e.g., gNB), or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

The quantity of four network entities is utilized for illustrative purposes and is not limiting. In the example of FIG. 7, the four network entities are located more or less on a perimeter of a circle 702; however, the depiction of the location of the four network entities on the perimeter of the circle 702 is for illustrative purposes and is not limiting. In other examples, similar network entities may be located with respect to one another in ways that do not correspond to locations on the perimeter of a circle. The first network entity 704 is depicted with a plurality of cells, including a current spCell 714 in a timing advance group (TAG) identified as TAG 0. The current spCell 714 serves the UE 712. The second network entity 706 is depicted with one candidate spCell, namely the second candidate spCell 718 in TAG 2. Additional cells are not depicted in connection with the second network entity 706 to avoid cluttering the drawing. A plurality of cells, including a first candidate spCell 716 in TAG 1 is depicted in connection with the third network entity 708. The fourth network entity 710 is depicted with one candidate spCell, namely the third candidate spCell 720 in TAG 3. Additional cells are not depicted in connection with the fourth network entity 710 to avoid cluttering the drawing.

As the UE 712 moves in the direction of the motion vector 722, the spCell serving the UE 712 may be reselected or updated. Reselection may move the spCell serving the UE 712 among the pre-configured candidate spCell set 700, to any of the first candidate spCell 716, the second candidate spCell 718, or the third candidate spCell 720. The reselecting or updating may be based on the L1 measurements performed by the UE 712 with reference to the candidate spCells. In the scenario of FIG. 7, the first candidate spCell 716, the second candidate spCell 718, and the third candidate spCell 720 are not activated before one of them is selected as the new spCell to serve the UE 712. In the illustrated example of FIG. 4, an L1 measurement of the first candidate spCell 716 in TAG 1 may be the strongest; therefore, the first candidate spCell 716 in TAG 1 may be selected as the new spCell serving the UE 712.

Although TAG 1 is associated with the first candidate spCell 716, TAG 2 is associated with the second candidate spCell 718, and TAG 3 is associated with the third candidate spCell 720, there could be other cells sharing the just-recited TAGs. In the scenario depicted in FIG. 7, all candidate cells in TAG 1, TAG 2, and TAG 3 were previously deactivated and may remain deactivated while TA values associated with each candidate spCell are updated and maintained at the UE 712. For example, all candidate cells sharing the TAG 1 as the new spCell in FIG. 7 are not activated before the first candidate spCell 716 in TAG 1 is selected as the new spCell serving the UE 712.

In the case of L1/L2 based mobility, determining and conveying timing advance, for example in instances involving spCell reselection or updating among network entities and a given UE involves some latency. Transmissions of reference signals from the given UE may need to be triggered, data may need to be collected, TA values based on the transmissions and/or data may need to be obtained, and TACs including the obtained TA values may need to be transmitted from one or more of the network entities to the given UE before an obtained TA value may be applied to uplink transmissions from the given UE. Such operations may occur with a handover from one network entity to another or in general in connection with a reselection of a spCell from a current spCell to a candidate spCell. In connection with L1/L2 based mobility, to reduce new spCell activation latency, TA values may be maintained with respect to deactivated candidate spCells, such that no TA update would be needed after a given deactivated candidate spCell is selected as a new spCell. The maintenance of TA values corresponding to deactivated spCells at the UE 712 facilitates low latency timing advance command indication in L1/L2 based mobility. Described herein may be aspects that relate to TA maintenance for deactivated cells and aspects that may reduce TA update latency involved in L1/L2 based mobility.

According to aspects described herein, commands that may presently be utilized for other things, such as for example, a spCell update command or a cell group (CG) update command, may be used to trigger a TA update associated with TAG(s) of a candidate spCell(s) or a candidate CG(s). By way of example, the triggered TA update by the spCell update command or the cell group update command may cause the UE 712 to transmit an uplink reference signal (RS) for TA measurement (e.g., PRACH or SRS transmitted from the UE 712 to the candidate spCell or the candidate CG) or may cause the UE 712 to report receiver (Rx) timing difference between an activated spCell associated with a network entity (a present or network entity associated with a spCell currently serving the UE 712) and the candidate spCell(s), based on which the network entity could derive the respective TA values(s) associated with the respective candidate spCell(s).

According to some aspects, a DCI-based TA indication may be considered. For example, TA indications may be carried by MAC-CEs or in connection with a random access response (RAR) upon initial access to a network entity. In addition, a DCI-based TA indication may be supported to reduce TA update latency and increase signaling flexibility. By way of example and not limitation, a DCI including a TA update may be enhanced based on a Release 17 TCI updating DCI, where reserved bits can be used to indicate the TA values when such a TCI updating DCI might not be utilized to schedule data. Other DCIs may also be used to carry a TA update. In some examples, the TA value indicated in the DCI may be applied after X symbols from the DCI, where X may be a predetermined number that may be, for example, incorporated into a standard document. In other words, the TA application time may be defined as being X symbols from the DCI. In some examples, the TA value indicated in DCI may be applied after Y symbols from an ACK associated with the DCI, where Y may be a predetermined number that may be, for example, incorporated into a standard document. In other words, the TA application time may be defined as being Y symbols from the ACK associated with the DCI. X and Y may or may not be equal. In another example, where the DCI including the TA update is a TCI updating DCI, the timing that is used to apply the TA (in other words, the TA application time) may be the same as a TCI application time (i.e., the timing that is used to apply the TCI).

According to another aspect, an spCell update DCI, or a CG update DCI, which may be utilized in L1/L2 mobility, may also be used to indicate the TA for a new spCell or a new CG, respectively. In examples including but not limited to the use of a TCI update DCI, an spCell update DCI, or a CG update DCI (or any combination thereof), the DCI may indicate a TA value and a TAG ID.

According to one example, the TAG ID may be explicitly indicated by the DCI (e.g., by the TCI update DCI, the spCell update DCI, or the CG update DCI (or any combination thereof)). In another example, the TAG ID may be implicitly determined as the TAG ID associated with the DCI. For example, the TAG ID associated with the TA may be the same as the TAG ID of the TCI update DCI, the spCell update DCI, or the CG update DCI (or any combination thereof).

According to another example, the update DCI may be a group-common DCI. According to such an example, a UE may be configured with one or more fields of TA indications, where the one or more fields are respectively associated with different TAG IDs. In such an example, the TA value indicated in the group-common DCI in association with a given TAG-ID may be applied after Z symbols from the update DCI, where Z may be a predetermined number that may be, for example, incorporated into a standard document.

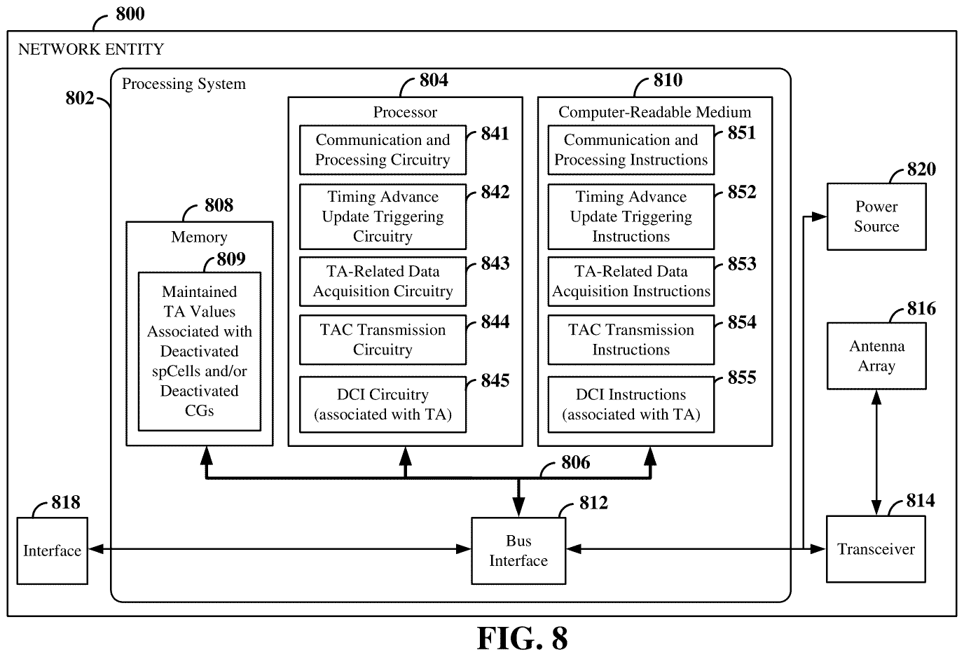

FIG. 8 is a block diagram illustrating an example of a hardware implementation of a network entity 800 employing a processing system 802 according to some aspects of the disclosure. The network entity 800 may be a scheduling entity and may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC as illustrated in any one or more of FIGS. 1, 2, 4, 5, 6, and/or 7.

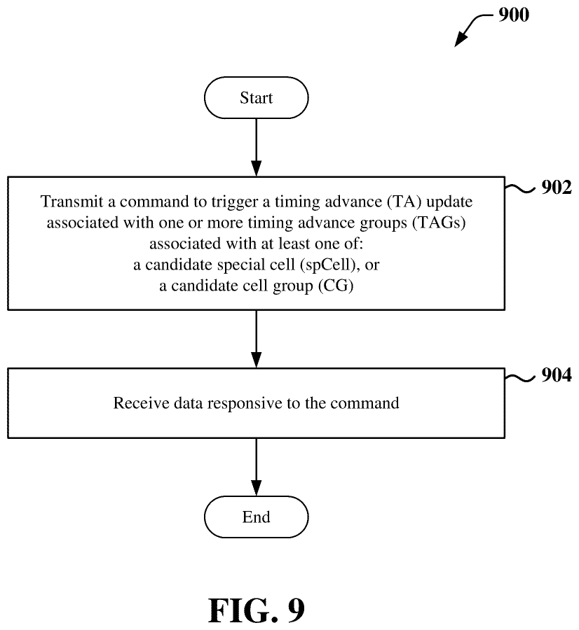

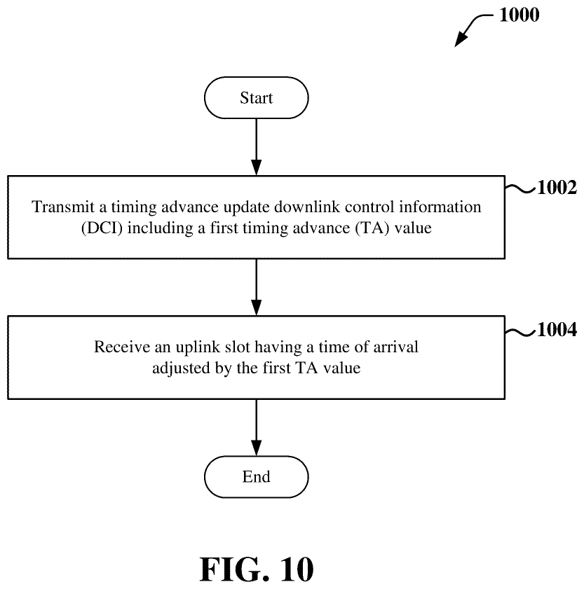

In accordance with various aspects of the disclosure, an element, or any portion of an element, or any combination of elements may be implemented with a processing system 802 that includes one or more processors, such as processor 804. Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 800 may be configured to perform any one or more of the functions described herein. That is, the processor 804, as utilized in the network entity 800, may be used to implement any one or more of the methods or processes described and illustrated, for example, in any one or more of FIGS. 9 and 10.

The processor 804 may in some examples be implemented via a baseband or modem chip and in other implementations, the processor 804 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 802 may be implemented with a bus architecture, represented generally by the bus 806. The bus 806 may include any number of interconnecting buses and bridges depending on the specific application of the processing system 802 and the overall design constraints. The bus 806 communicatively couples together various circuits, including one or more processors (represented generally by the processor 804), a memory 808, and computer-readable media (represented generally by the computer-readable medium 810). The bus 806 may also link various other circuits such as timing sources, peripherals, voltage regulators, and power management circuits, which are well known in the art, and therefore, will not be described any further.

A bus interface 812 provides an interface between the bus 806 and a transceiver 814. The transceiver 814 may be a wireless transceiver. The transceiver 814 may provide a means for communicating with various other apparatus over a transmission medium (e.g., air interface). The transceiver 814 may further be coupled to one or more antenna arrays (hereinafter antenna array 816). The bus interface 812 further provides an interface between the bus 806 and a user interface 818 (e.g., keypad, display, touch screen, speaker, microphone, control features, etc.). Of course, such a user interface 818 is optional and may be omitted in some examples. In addition, the bus interface 812 further provides an interface between the bus 806 and a power source 820 of the network entity 800.

The processor 804 is responsible for managing the bus 806 and general processing, including the execution of software stored on the computer-readable medium 810. The software, when executed by the processor 804, causes the processing system 802 to perform the various functions described below for any particular apparatus. The computer-readable medium 810 and the memory 808 may also be used for storing data that is manipulated by the processor 804 when executing software. The data may include data in table(s), such as maintained TA values of deactivated spCells and/or deactivated CGs 809 according to some aspects of the disclosure.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 810. When executed by the processor 804, the software may cause the processing system 802 to perform the various processes and functions described herein for any particular apparatus.

The computer-readable medium 810 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 810 may reside in the processing system 802, external to the processing system 802, or distributed across multiple entities including the processing system 802. The computer-readable medium 810 may be embodied in a computer program product or article of manufacture. By way of example, a computer program product or article of manufacture may include a computer-readable medium in packaging materials. In some examples, the computer-readable medium 810 may be part of the memory 808. Those skilled in the art will recognize how best to implement the described functionality presented throughout this disclosure depending on the particular application and the overall design constraints imposed on the overall system.

In some aspects of the disclosure, the processor 804 may include communication and processing circuitry 841 configured for various functions, including, for example, communicating with other network entities, a network core (e.g., a 5G core network), one or more user equipment or wireless communication devices, or any other entity, such as, for example, local infrastructure or an entity communicating with the network entity 800 via the Internet, such as a network provider. In some examples, the communication and processing circuitry 841 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 841 may include one or more transmit/receive chains.

In some implementations where the communication involves receiving information, the communication and processing circuitry 841 may obtain or identify information from a component of the network entity 800 (e.g., from the transceiver 814 that receives the information via radio frequency signaling or some other type of signaling suitable for the applicable communication medium), process (e.g., decode) the information, and output the processed information. For example, the communication and processing circuitry 841 may output the information to another component of the processor 804, to the memory 808, or to the bus interface 812. In some examples, the communication and processing circuitry 841 may receive one or more of: signals, messages, other information, or any combination thereof. In some examples, the communication and processing circuitry 841 may receive information via one or more channels. In some examples, the communication and processing circuitry 841 may include functionality for a means for receiving. In some examples, the communication and processing circuitry 841 may include functionality for a means for processing, including a means for demodulating, a means for decoding, etc.

In some implementations where the communication involves sending (e.g., transmitting) information, the communication and processing circuitry 841 may obtain or identify information from a component of the network entity 800 (e.g., from the processor 804, the memory 808, or the bus interface 812), process (e.g., modulate, encode, etc.) the information, and output the processed information. For example, the communication and processing circuitry 841 may obtain data stored in the memory 808 and may process the obtained data according to some aspects of the disclosure. For example, the communication and processing circuitry 841 may determine a value of TA to be conveyed to a UE. The value of the TA may be determined from data (e.g., including reports) received from a UE. The value of the TA may be stored in the memory 808 in, for example, a table of maintained TA values of deactivated spCells and/or deactivated CGs 809 according to some aspects.

In some examples, the communication and processing circuitry 841 may obtain information and may output the information to the transceiver 814 (e.g., that transmits the information via radio frequency signaling or some other type of signaling suitable for the applicable communication medium). In some examples, the communication and processing circuitry 841 may send one or more of signals, messages, other information, or any combination thereof. In some examples, the communication and processing circuitry 841 may send information via one or more channels. In some examples, the communication and processing circuitry 841 may include functionality for a means for sending (e.g., a means for transmitting). In some examples, the communication and processing circuitry 841 may include functionality for a means for generating, including a means for modulating, a means for encoding, etc. In some examples, the communication and processing circuitry 841 may be configured to receive and process uplink traffic and uplink control messages (e.g., similar to uplink traffic 116 and uplink control 118 of FIG. 1) and process and transmit downlink traffic and downlink control messages (e.g., similar to downlink traffic 112 and downlink control 114 of FIG. 1) via the antenna array 816 and the transceiver 814. According to some aspects, the communication and processing circuitry 841 may be configured to receive an uplink slot having a time of arrival adjusted by a first TA value.

The communication and processing circuitry 841 may further be configured to execute communication and processing instructions 851 (e.g., software) stored on the computer-readable medium 810 to implement one or more functions described herein.

In some aspects of the disclosure, the processor 804 may include timing advance update triggering circuitry 842. The timing advance update triggering circuitry 842 may be configured for various functions, including, for example, transmitting a command to trigger a timing advance (TA) update associated with one or more timing advance groups (TAGs) associated with at least one of: a candidate special cell (spCell), or a candidate cell group (CG). In some examples, the command may be an L2 command, such as a MAC-CE. According to some aspects, the at least one of the candidate spCell is a deactivated candidate spCell and the candidate CG is a deactivated candidate CG. The TA update may be associated with maintenance of a TA associated with at least one of the deactivated candidate spCell, or the deactivated candidate CG. The maintenance of the TA value may refer to maintenance of the TA value at the network entity 800 (e.g., in the memory 808) or at the UE (e.g., in a memory of the UE). When maintained at the UE, a low latency may be obtained by applying the maintained TA value to the candidate spCell or the candidate CG as soon as the candidate spCell or the candidate CG is activated.

According to some aspects, the network entity 800 may correspond to an activated cell (e.g., an activated spCell, an activated CG), and the at least one of: the candidate special cell (spCell), or the candidate cell group (CG) corresponds to a deactivated cell. According to some aspects, the command may be at least one of: an spCell update command, or a CG update command. The timing advance update triggering circuitry 842 may further be configured to execute timing advance update triggering instructions 852 (e.g., software) stored on the computer-readable medium 810 to implement one or more functions described herein.

In some aspects of the disclosure, the processor 804 may include TA-related data acquisition circuitry 843. The TA-related data acquisition circuitry 843 may be configured for various functions, such as receiving data responsive to the command (i.e., the transmitted command to trigger a timing advance (TA) update). In one example, the data may be in the form of a report of received timing difference between a current spCell serving the UE and a candidate spCell that may be activated to serve the UE. Based on the report of the received timing difference, the TA-related data acquisition circuitry 843, alone or in combination with, for example, the communication and processing circuitry 841 may obtain (e.g., determine, derive) the TA to be used by the UE in connection with the candidate spCell. The TA-related data acquisition circuitry 843 may further be configured to execute TA-related data acquisition instructions 853 (e.g., software) stored on the computer-readable medium 810 to implement one or more functions described herein.

In some aspects of the disclosure, the processor 804 may include TAC transmission circuitry 844. The TAC transmission circuitry 844 may be configured for various functions, including, for example, transmitting a TAC, including the TA update associated with the one or more TAGS (associated with the at least one of: the candidate special cell (spCell), or the candidate cell group (CG)) to a user equipment. The TAC transmission circuitry 844 may further be configured to execute TAC transmission instructions 854 (e.g., software) stored on the computer-readable medium 810 to implement one or more functions described herein.

In some aspects of the disclosure, the processor 804 may include DCI circuitry 845. The DCI circuitry 845 may be associated with aspects of timing advance described herein. The DCI circuitry 845 may be configured for various functions, including, for example, transmitting a DCI including a first TA value. The DCI may be formatted to include timing advance data. The DCI may be transmitted to a UE, for example. The DCI circuitry 845 may further be configured to include a second TA value with the DCI, the second TA value may be associated with at least one of: a candidate special cell (spCell), or a candidate cell group (CG), for example. In other examples, the DCI may be configured to include the first TA value and the second TA value.

According to some aspects, the DCI may be a transmission configuration indicator (TCI) update DCI. In some examples, the first TA value, and/or the second TA value, included in the TCI update DCI may be applied (at the UE) at a same time as the TCI is applied. In some examples, the first TA value, and/or the second TA value, included in the DCI may be applied after a predetermined number of symbols from the DCI. In other examples, the first TA value, and/or the second TA value, included in the DCI may be applied after a predetermined number of symbols from an acknowledgment (ACK) corresponding to the DCI.

In some aspects, the DCI may include a timing advance group identifier (TAG ID). In some examples, the TAG ID may be indicated by the DCI. In other examples, the TAG ID may be implicitly determined from a parameter associated with the DCI.

In some aspects, the DCI may be a group-common DCI including one or more fields of TA values, where each of the one or more fields may be associated with a timing advance group identifier (TAG ID). In some examples, a respective one of the one or more fields of TA values included in the group-common DCI may be applied after a predetermined number of symbols from the group-common DCI.

The DCI circuitry 845 may further be configured to execute DCI instructions 855 (e.g., software) stored on the computer-readable medium 810 to implement one or more functions described herein. The DCI instructions 855 may be associated with aspects of timing advance as described herein.

FIG. 9 is a flow chart illustrating an exemplary process 900 (e.g., a method of wireless communication) at a network entity according to some aspects of the disclosure. The process 900 may occur in a wireless communication network, such as the wireless communication networks of FIGS. 1, 2, 4, 5, 6, and/or 7, for example. As described below, some or all illustrated features may be omitted in a particular implementation within the scope of the present disclosure, and some illustrated features may not be required for all implementations. In some examples, the process 900 may be carried out by the network entity 800 described and illustrated in connection with FIG. 8. In some examples, the process 900 may be carried out by any suitable apparatus or means for carrying out the functions or algorithms described herein.

At block 902, the network entity may transmit a command to trigger a timing advance (TA) update associated with one or more timing advance groups (TAGs) associated with at least one of: a candidate special cell (spCell), or a candidate cell group (CG). For example, the timing advance update triggering circuitry 842, shown and described above in connection with FIG. 8, may provide a means for transmitting a command to trigger a timing advance (TA) update associated with one or more timing advance groups (TAGs) associated with at least one of: a candidate special cell (spCell), or a candidate cell group (CG). According to some aspects, the candidate spCell is a deactivated candidate spCell and the candidate CG is a deactivated candidate CG, and the TA update is associated with maintenance at a user equipment of a TA value associated with at least one of the deactivated candidate spCell, or the deactivated candidate CG. In some examples, the network entity may correspond to an activated cell and the at least one of: the candidate spCell, or the candidate CG may correspond to a deactivated cell. In some examples, the command may be at least one of: an spCell update command, or a CG update command.

According to some aspects, the network entity may transmit a timing advance command (TAC), including the TA update associated with the one or more TAGS, to a user equipment. For example, the TAC transmission circuitry 844, shown and described above in connection with FIG. 8, may provide a means for transmitting a timing advance command (TAC), including the TA update associated with the one or more TAGS to a user equipment.

At block 904, the network entity may receive data responsive to the command (i.e., the command to trigger a timing advance (TA) update). For example, the communication and processing circuitry 841 as shown and described in connection with FIG. 8, may provide a means for receiving data responsive to the command.

FIG. 10 is a flow chart illustrating an exemplary process 1000 (e.g., a method of wireless communication) at a network entity according to some aspects of the disclosure. The process 1000 may occur in a wireless communication network, such as the wireless communication networks of FIGS. 1, 2, 4, 5, 6, and/or 7, for example. As described below, some or all illustrated features may be omitted in a particular implementation within the scope of the present disclosure, and some illustrated features may not be required for all implementations. In some examples, the process 1000 may be carried out by the network entity 800 described and illustrated in connection with FIG. 8. In some examples, the process 1000 may be carried out by any suitable apparatus or means for carrying out the functions or algorithms described herein.

At block 1002, the network entity may transmit a downlink control information (DCI) including a first timing advance (TA) value. According to some aspects, the first TA value may be associated with at least one of: a candidate special cell (spCell), or a candidate cell group (CG). According to other aspects, the network entity may include a second TA value with the DCI, the second TA value being associated with at least one of: a candidate special cell (spCell), or a candidate cell group (CG). For example, the DCI circuitry 845, shown and described above in connection with FIG. 8, may provide a means for transmitting a DCI including a first timing advance (TA) value and/or a second TA value.

In some examples, the DCI may be a transmission configuration indicator (TCI) update DCI. In such examples, the first TA value included in the TCI update DCI may be applied at a same time as the TCI is applied.

In some examples, the first TA value included in the DCI may be applied after a predetermined number of symbols from the DCI. According to some aspects, the first TA value included in the DCI may be applied after a predetermined number of symbols from an acknowledgment (ACK) corresponding to the DCI.

According to some aspects, the DCI includes a timing advance group identifier (TAG ID). In some examples, the TAG ID may be indicated by the DCI. In some examples, the TAG ID may be implicitly determined from a parameter associated with the DCI.

According to some aspects, the DCI may be a group-common DCI including one or more fields of TA values, wherein each of the one or more fields is associated with a timing advance group identifier (TAG ID). In some examples, a respective one of the one or more fields of TA values included in the group-common DCI may be applied after a predetermined number of symbols from the group-common DCI.

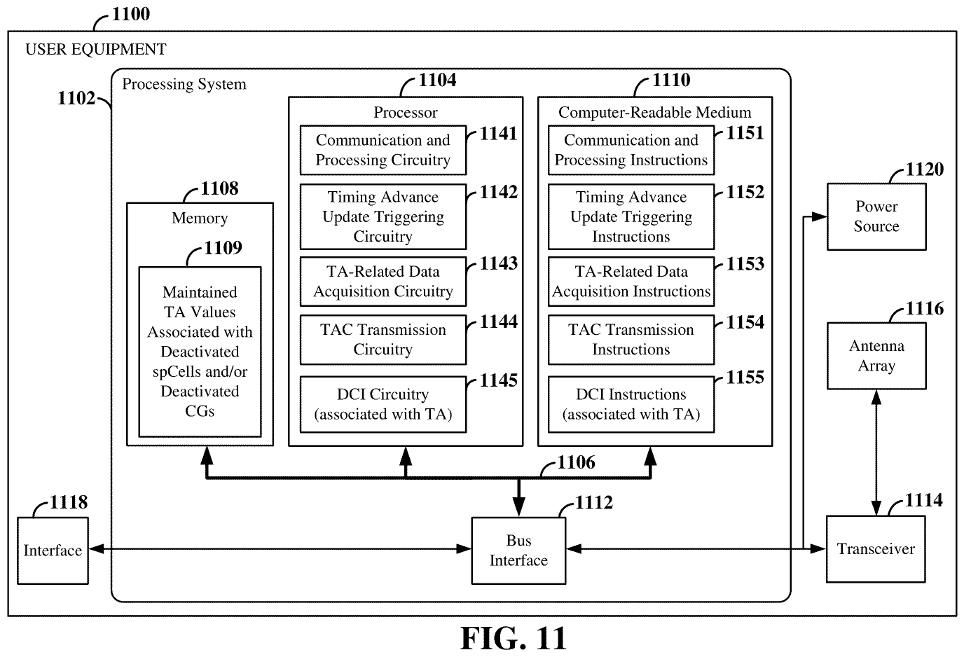

FIG. 11 is a block diagram illustrating an example of a hardware implementation of user equipment (UE) 1100 (e.g., a scheduled entity, a wireless communication device, a mobile device) employing a processing system 1102 according to some aspects of the disclosure. The UE 1100 may be, for example, any UE, scheduled entity, or wireless communication device as illustrated in any one or more of FIGS. 1, 2, 4, 5, 6, and/or 7. In accordance with various aspects of the disclosure, an element, or any portion of an element, or any combination of elements may be implemented with a processing system 1102 that includes one or more processors, such as processor 1104. The processing system 1102 may be substantially the same as the processing system 802 illustrated and described in connection with FIG. 8, including a bus interface 1112, a bus 1106, a memory 1108, a processor 1104, and a computer-readable medium 1110. Furthermore, the UE 1100 may include a user interface 1118, a transceiver 1114, an antenna array(s) 1116, and a power source 1120, substantially similar to those described above in connection with FIG. 8. Accordingly, their descriptions will not be repeated for the sake of brevity.

In some aspects of the disclosure, the processor 1104 may include communication and processing circuitry 1141 configured for various functions, including, for example, communicating with other UEs or wireless communication devices, network entities, a network core (e.g., a 5G core network), or any other entity, such as, for example, local infrastructure or an entity communicating with the UE 1100 via the Internet, such as a network provider. In some examples, the communication and processing circuitry 1141 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1141 may include one or more transmit/receive chains.

In some implementations where the communication involves receiving information, the communication and processing circuitry 1141 may obtain or identify information from a component of the UE 1100 (e.g., from the transceiver 1114 that receives the information via radio frequency signaling or some other type of signaling suitable for the applicable communication medium), process (e.g., decode) the information, and output the processed information. For example, the communication and processing circuitry 1141 may output the information to another component of the processor 1104, to the memory 1108, or to the bus interface 1112. In some examples, the communication and processing circuitry 1141 may receive one or more of: signals, messages, other information, or any combination thereof. In some examples, the communication and processing circuitry 1141 may receive information via one or more channels. In some examples, the communication and processing circuitry 1141 may include functionality for a means for receiving. In some examples, the communication and processing circuitry 1141 may include functionality for a means for processing, including a means for demodulating, a means for decoding, etc.

In some implementations where the communication involves sending (e.g., transmitting) information, the communication and processing circuitry 1141 may obtain or identify information from a component of the UE 1100 (e.g., from the processor 1104, the memory 1108, or the bus interface 1112), process (e.g., modulate, encode, etc.) the information, and output the processed information. For example, the communication and processing circuitry 1141 may obtain data stored in the memory 1108 and may process the obtained data according to some aspects of the disclosure.

In some examples, the communication and processing circuitry 1141 may obtain information and may output the information to the transceiver 1114 (e.g., that transmits the information via radio frequency signaling or some other type of signaling suitable for the applicable communication medium). In some examples, the communication and processing circuitry 1141 may send one or more of signals, messages, other information, or any combination thereof. In some examples, the communication and processing circuitry 1141 may send information via one or more channels. In some examples, the communication and processing circuitry 1141 may include functionality for a means for sending (e.g., a means for transmitting). In some examples, the communication and processing circuitry 1141 may include functionality for a means for generating, including a means for modulating, a means for encoding, etc. In some examples, the communication and processing circuitry 1141 may be configured to receive and process downlink traffic and downlink control messages (e.g., similar to downlink traffic 112 and downlink control 114 of FIG. 1) and process and transmit uplink traffic and uplink control messages (e.g., similar to uplink traffic 116 and uplink control 118 of FIG. 1) via the antenna array 1116 and the transceiver 1114. According to some aspects, the communication and processing circuitry 1141 may be configured to transmit an uplink slot having a time of transmission adjusted by a first TA value.

The communication and processing circuitry 1141 may further be configured to execute communication and processing instructions 1151 (e.g., software) stored on the computer-readable medium 1110 to implement one or more functions described herein.

In some aspects of the disclosure, the processor 1104 may include timing advance update triggering circuitry 1142. The timing advance update triggering circuitry 1142 may be configured for various functions, including, for example, transmitting a command to trigger a timing advance (TA) update associated with one or more timing advance groups (TAGs) associated with at least one of: a candidate special cell (spCell), or a candidate cell group (CG). In some examples, the command may be an L2 command, such as a MAC-CE. According to some aspects, the command may be the command configured to cause a user equipment to measure data associated with a determination of the timing advance update based on a distance between the user equipment and the at least one of the candidate spCell, or the candidate CG, respectively. According to some aspects, the network entity may correspond to an activated cell (e.g., an activated spCell, an activated CG), and the at least one of: the candidate special cell (spCell), or the candidate cell group (CG) my correspond to a deactivated cell. According to some aspects, the command may be at least one of: an spCell update command, or a CG update command. The timing advance update triggering circuitry 1142 may further be configured to execute timing advance update triggering instructions 1152 (e.g., software) stored on the computer-readable medium 1110 to implement one or more functions described herein.

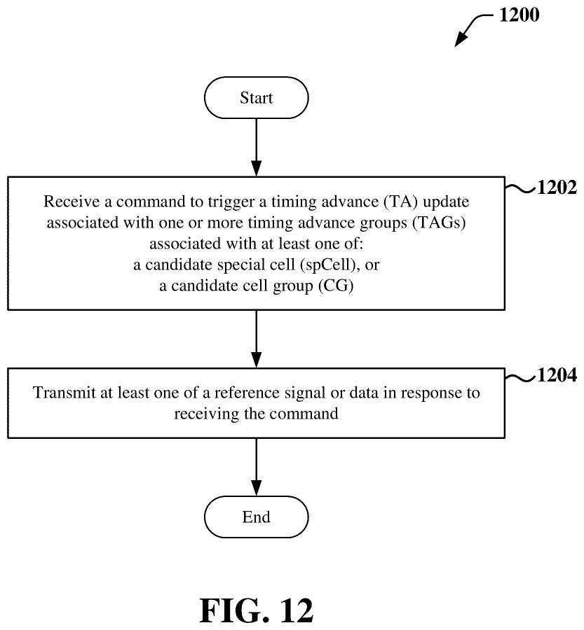

FIG. 12 is a flow chart illustrating an exemplary process 1200 (e.g., a method of wireless communication) at a user equipment according to some aspects of the disclosure. The process 1200 may occur in a wireless communication network, such as the wireless communication networks of FIGS. 1, 2, 4, 5, 6, and/or 7, for example. As described below, some or all illustrated features may be omitted in a particular implementation within the scope of the present disclosure, and some illustrated features may not be required for all implementations. In some examples, the process 1200 may be carried out by the user equipment 1100 described and illustrated in connection with FIG. 11. In some examples, the process 1200 may be carried out by any suitable apparatus or means for carrying out the functions or algorithms described herein.

At block 1202, the user equipment may receive a command to trigger a timing advance (TA) update associated with one or more timing advance groups (TAGs) associated with at least one of: a candidate special cell (spCell), or a candidate cell group (CG). For example, the timing advance update triggering circuitry 1142, shown and described above in connection with FIG. 11, may provide a means for receiving a command to trigger a timing advance (TA) update associated with one or more timing advance groups (TAGs) associated with at least one of: a candidate special cell (spCell), or a candidate cell group (CG).

According to some aspects, the candidate spCell may be a deactivated candidate spCell and the candidate CG may be a deactivated candidate CG. The TA update may be associated with maintenance at the UE of a TA value associated with the at least one of the deactivated candidate spCell, or the deactivated candidate CG. For example, the memory 1108 of the UE 1100 may store maintained TA values associated with deactivated spCells and/or deactivated CGs 1109.

According to some aspects, the command may be at least one of: an spCell update command, or a CG update command.

According to some aspects, the reference signal may be an uplink reference signal, and the processor of the UE may be further configured to: receive an updated TA value from the at least one of: the candidate special cell (spCell), or the candidate cell group (CG) in response to transmitting the reference signal; and store the updated TA value as a maintained TA value associated with the at least one of: the candidate special cell (spCell), or the candidate cell group (CG). In some examples, the reference signal may be at least one of: a sounding reference signal (SRS), or a random access preamble carried by a physical random access channel (PRACH).

According to some aspects, the data may correspond to a report of a receive (Rx) timing difference between a present (current) serving cell, such as an activated spCell associated with the network entity (e.g., the first network entity 704 associated with a current spCell 714 as shown and described in connection with FIG. 7) and the candidate spCell (that may be associated with other network entities) (e.g., the first candidate spCell 716 associated with the third network entity 708, the second candidate spCell 718 associated with second network entity 706, and third candidate spCell 720 associated with the fourth network entity 710, all as shown and described in connection with FIG. 7). Based on the data, the network entity transmitting the command (e.g., the first network entity 704 of FIG. 7) may derive the TA value that the user equipment (e.g., the UE 712 of FIG. 7) may use in association with each of the candidate spCells (e.g., the candidate spCells 716, 718, and 720 of FIG. 7).

In some examples, the network entity from which the UE receives the command, may correspond to an activated cell and the at least one of: the candidate special cell (spCell), or the candidate cell group (CG) may correspond to a deactivated cell.

According to some aspects, the UE may receive a timing advance command (TAC), including the TA value associated with the TA update. The TA value may be associated with the one or more TAGs by the network entity that transmitted the command. For example, the TAC transmission circuitry 1144, shown and described above in connection with FIG. 11, may provide a means for receiving a timing advance command (TAC), including the TA value associated with the TA update and associated with the one or more TAGs.

At block 1204, the UE may transmit at least one of a reference signal or data in response to receiving the command (e.g., transmit the PRACH or SRS and/or the data corresponding the Rx report as described above). For example, the communication and processing circuitry 1141, as shown and described in connection with FIG. 11, may provide a means for transmitting at least one of a reference signal or data in response to receiving the command.

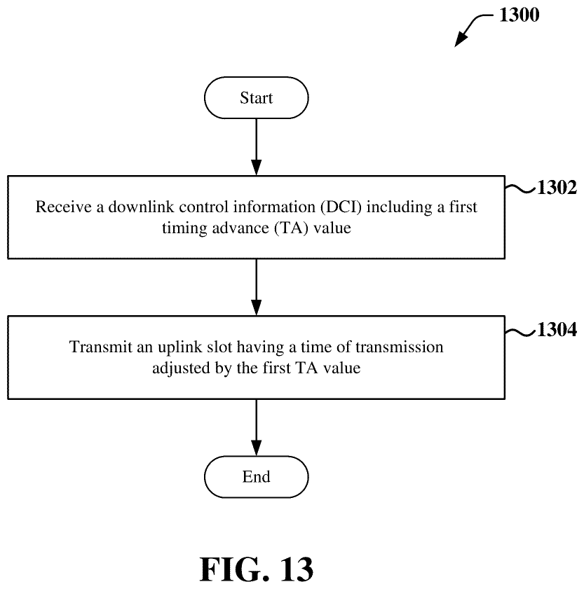

FIG. 13 is a flow chart illustrating an exemplary process 1300 (e.g., a method of wireless communication) at a user equipment (UE) according to some aspects of the disclosure. The process 1300 may occur in a wireless communication network, such as the wireless communication networks of FIGS. 1, 2, 4, 5, 6, and/or 7, for example. As described below, some or all illustrated features may be omitted in a particular implementation within the scope of the present disclosure, and some illustrated features may not be required for all implementations. In some examples, the process 1300 may be carried out by the UE 1100 described and illustrated in connection with FIG. 11. In some examples, the process 1300 may be carried out by any suitable apparatus or means for carrying out the functions or algorithms described herein.

At block 1302, the UE may receive a downlink control information (DCI) including a first timing advance (TA) value. According to some aspects, the first TA value may be associated with a current spCell or PCell presently serving the UE. According to some aspects, the first TA may be associated with at least one of: a candidate special cell (spCell), or a candidate cell group (CG). According to other aspects, the DCI may include the first TA value (e.g., associated with a current spCell or PCell presently serving the UE) and a second TA value. The second TA value may be associated with at least one of: a candidate special cell (spCell), or a candidate cell group (CG). For example, the DCI circuitry 1145, shown and described above in connection with FIG. 11, may provide a means for transmitting a DCI including a first timing advance (TA) value and/or a second TA value. In some examples, the at least one of: the candidate spCell is a deactivated candidate spCell, or the candidate CG is a deactivated candidate CG.

In some examples, the DCI may be a transmission configuration indicator (TCI) update DCI. In such examples, the first TA value included in the TCI update DCI may be applied at a same time as the TCI is applied. In some examples, the first TA value included in the DCI may be applied after a predetermined number of symbols from the DCI. According to some aspects, the first TA value included in the DCI may be applied after a predetermined number of symbols from an acknowledgment (ACK) corresponding to the DCI.

According to some aspects, the DCI includes a timing advance group identifier (TAG ID). In some examples, the DCI may indicate the TAG ID. In some examples, the TAG ID may be implicitly determined from a parameter associated with the DCI.

According to some aspects, the DCI may be a group-common DCI including one or more fields of TA values, wherein each of the one or more fields is associated with a timing advance group identifier (TAG ID). In some examples, a respective one of the one or more fields of TA values included in the group-common DCI and associated with a given TAG ID may be applied after a predetermined number of symbols from the group-common DCI.

Of course, in the above examples, the circuitry included in the processor 804 and/or processor 1004 is merely provided as an example. Other means for carrying out the described processes or functions may be included within various aspects of the present disclosure, including but not limited to the instructions stored in the computer-readable medium 810 and/or computer-readable medium 1010, respectively, or any other suitable apparatus or means described in any one of the FIGS. 1, 2, 4, 5, 6, 7, 8, and/or 11 and utilizing, for example, the processes and/or algorithms described herein in relation to FIGS. 9, 10, 12, and/or 13.

The following provides an overview of aspects of the present disclosure:
Aspect 1: A network entity, comprising: a memory, and a processor coupled to the memory, the processor being configured to: transmit a command to trigger a timing advance (TA) update associated with one or more timing advance groups (TAGs) associated with at least one of: a candidate special cell (spCell), or a candidate cell group (CG), and receive data responsive to the command.
Aspect 2: The network entity of aspect 1, wherein the at least one of the candidate spCell is a deactivated candidate spCell, or the candidate CG is a deactivated candidate CG, and the TA update is associated with maintenance at a user equipment of a TA value associated with at least one of the deactivated candidate spCell, or the deactivated candidate CG.
Aspect 3: The network entity of aspect 1 or 2, wherein the network entity corresponds to an activated cell and the at least one of: the candidate special cell (spCell), or the candidate cell group (CG) corresponds to a deactivated cell.
Aspect 4: The network entity of any of aspects 1 through 3, wherein the command is at least one of: an spCell update command, or a CG update command.
Aspect 5: The network entity of any of aspects 1 through 4, the processor being further configured to: transmit a timing advance command (TAC), including the TA update associated with the one or more TAGS to a user equipment.
Aspect 6: A network entity, comprising: a memory, and a processor coupled to the memory, the processor being configured to: transmit a downlink control information (DCI) including a first timing advance (TA) value, and receive an uplink slot having a time of arrival adjusted by the first TA value.
Aspect 7: The network entity of aspect 6, the processor being further configured to: include a second TA value with the DCI, the second TA value being associated with at least one of: a candidate special cell (spCell), or a candidate cell group (CG).
Aspect 8: The network entity of aspect 6 or 7, wherein the DCI is a transmission configuration indicator (TCI) update DCI.
Aspect 9: The network entity of aspect 8, wherein the first TA value included in the TCI update DCI is applied at a same time as the TCI is applied.
Aspect 10: The network entity of any of aspects 6 through 9, wherein the first TA value included in the DCI is applied after a predetermined number of symbols from the DCI.
Aspect 11: The network entity of any of aspects 6 through 10, wherein the first TA value included in the DCI is applied after a predetermined number of symbols from an acknowledgment (ACK) corresponding to the DCI.
Aspect 12: The network entity of any of aspects 6 through 11, wherein the DCI includes a timing advance group identifier (TAG ID).
Aspect 13: The network entity of aspect 12, wherein the DCI indicates the TAG ID.
Aspect 14: The network entity of aspect 12, wherein the TAG ID is implicitly determined from a parameter associated with the DCI.
Aspect 15: The network entity of any of aspects 6 through 14, wherein the DCI is a group-common DCI including one or more fields of TA values, wherein each of the one or more fields is associated with a timing advance group identifier (TAG ID).
Aspect 16: The network entity of aspect 15, wherein a respective one of the one or more fields of TA values included in the group-common DCI is applied after a predetermined number of symbols from the group-common DCI.
Aspect 17: A user equipment, comprising: a memory, and a processor coupled to the memory, the processor being configured to: receive a command to trigger a timing advance (TA) update associated with one or more timing advance groups (TAGs) associated with at least one of: a candidate special cell (spCell), or a candidate cell group (CG), and transmit at least one of a reference signal or data in response to receiving the command.
Aspect 18: The user equipment of aspect 17, wherein the candidate spCell is a deactivated candidate spCell and the candidate CG is a deactivated candidate CG, and the TA update is associated with maintenance at the user equipment of a TA value associated with the at least one of the deactivated candidate spCell, or the deactivated candidate CG.
Aspect 19: The user equipment of aspect 17 or 18, wherein the command is at least one of: an spCell update command, or a CG update command.
Aspect 20: The user equipment of any of aspects 17 through 19, wherein the reference signal is an uplink reference signal, and the processor is further configured to: receive an updated TA value from the at least one of: the candidate special cell (spCell), or the candidate cell group (CG) in response to transmitting the reference signal; and store the updated TA value as a maintained TA value associated with the at least one of: the candidate special cell (spCell), or the candidate cell group (CG).
Aspect 21: The user equipment of any of aspects 17 through 20, wherein the reference signal is at least one of: a sounding reference signal (SRS), or a random access preamble carried by a physical random access channel (PRACH).
Aspect 22: The user equipment of any of aspects 17 through 21, wherein the data corresponds to a report of a receive (Rx) timing difference between an activated spCell associated with a network entity and the candidate spCell.
Aspect 23. A user equipment, comprising: a memory, and a processor coupled to the memory, the processor being configured to: receive a downlink control information (DCI) including a first timing advance (TA) value, and transmit an uplink slot having a time of transmission adjusted by the first TA value.
Aspect 24: The user equipment of aspect 23, the processor being further configured to: receive a second TA value included with the DCI, the second TA value being associated with at least one of: a candidate special cell (spCell), or a candidate cell group (CG).
Aspect 25: The user equipment of aspect 24, wherein at least one of: the candidate spCell is a deactivated candidate spCell, or the candidate CG is a deactivated candidate CG.
Aspect 26: The user equipment of any of aspects 23 through 25, wherein the DCI is a transmission configuration indicator (TCI) update DCI.
Aspect 27: The user equipment of any of aspects 23 through 26, wherein the first TA value included in the DCI is applied after a predetermined number of symbols from the DCI.
Aspect 28: The user equipment of any of aspects 23 through 27, wherein the first TA value included in the DCI is applied after a predetermined number of symbols from an acknowledgment (ACK) corresponding to the DCI.
Aspect 29: The user equipment of any of aspects 23 through 28, wherein the DCI includes a timing advance group identifier (TAG ID).
Aspect 30: The user equipment of any of aspects 23 through 29, wherein the DCI is a group-common DCI including one or more fields of TA values, wherein each of the one or more fields is associated with a timing advance group identifier (TAG ID).
Aspect 31: A method operational at a network entity, comprising: transmitting a command to trigger a timing advance (TA) update associated with one or more timing advance groups (TAGs) associated with at least one of: a candidate special cell (spCell), or a candidate cell group (CG); and receiving data responsive to the command.
Aspect 32: The method of aspect 31, wherein the at least one of the candidate spCell is a deactivated candidate spCell, or the candidate CG is a deactivated candidate CG, and the TA update is associated with maintenance at a user equipment of a TA value associated with at least one of the deactivated candidate spCell, or the deactivated candidate CG.
Aspect 33: The method of aspect 31 or 32, wherein the network entity corresponds to an activated cell and the at least one of: the candidate special cell (spCell), or the candidate cell group (CG) corresponds to a deactivated cell.
Aspect 34: The method of any of aspects 31 through 33, wherein the command is at least one of: an spCell update command, or a CG update command.
Aspect 35: The method of any of aspects 31 through 34, further comprising: transmitting a timing advance command (TAC), including the TA update associated with the one or more TAGS to a user equipment.
Aspect 36: A method operational at a network entity, comprising: transmitting a downlink control information (DCI) including a first timing advance (TA) value; and receiving an uplink slot having a time of arrival adjusted by the first TA value.
Aspect 37: The method of aspect 36, further comprising: including a second TA value with the DCI, the second TA value being associated with at least one of: a candidate special cell (spCell), or a candidate cell group (CG).
Aspect 38: The method of aspect 36 or 37, wherein the DCI is a transmission configuration indicator (TCI) update DCI.
Aspect 39: The method of aspect 38, wherein the first TA value included in the TCI update DCI is applied at a same time as the TCI is applied.
Aspect 40: The method of any of aspects 36 through 39, wherein the first TA value included in the DCI is applied after a predetermined number of symbols from the DCI.
Aspect 41: The method of any of aspects 36 through 40, wherein the first TA value included in the DCI is applied after a predetermined number of symbols from an acknowledgment (ACK) corresponding to the DCI.
Aspect 42: The method of any of aspects 36 through 41, wherein the DCI includes a timing advance group identifier (TAG ID).
Aspect 43: The method of aspect 42, wherein the DCI indicates the TAG ID.
Aspect 44: The method of aspect 42, wherein the TAG ID is implicitly determined from a parameter associated with the DCI.
Aspect 45: The method of any of aspects 36 through 44, wherein the DCI is a group-common DCI including one or more fields of TA values, wherein each of the one or more fields is associated with a timing advance group identifier (TAG ID).
Aspect 46: The method of aspect 45, wherein a respective one of the one or more fields of TA values included in the group-common DCI is applied after a predetermined number of symbols from the group-common DCI.
Aspect 47: A method operational at a user equipment, comprising: receiving a command to trigger a timing advance (TA) update associated with one or more timing advance groups (TAGs) associated with at least one of: a candidate special cell (spCell), or a candidate cell group (CG); and transmitting at least one of a reference signal or data in response to receiving the command.
Aspect 48: The method of aspect 47, wherein the candidate spCell is a deactivated candidate spCell and the candidate CG is a deactivated candidate CG, and the TA update is associated with maintenance at the user equipment of a TA value associated with the at least one of the deactivated candidate spCell, or the deactivated candidate CG.
Aspect 49: The method of aspect 47 or 48, wherein the command is at least one of: an spCell update command, or a CG update command.
Aspect 50: The method of any of aspects 47 through 49, wherein the reference signal is an uplink reference signal, the method further comprising: receiving an updated TA value from the at least one of: the candidate special cell (spCell), or the candidate cell group (CG) in response to transmitting the reference signal; and storing the updated TA value as a maintained TA value associated with the at least one of: the candidate special cell (spCell), or the candidate cell group (CG).
Aspect 51: The method of any of aspects 47 through 50, wherein the reference signal is at least one of: a sounding reference signal (SRS), or a random access preamble carried by a physical random access channel (PRACH).
Aspect 52: The method of any of aspects 47 through 51, wherein the data corresponds to a report of a receive (Rx) timing difference between an activated spCell associated with a network entity and the candidate spCell.
Aspect 53. A method operational at a user equipment, comprising: receiving a downlink control information (DCI) including a first timing advance (TA) value; and transmitting an uplink slot having a time of transmission adjusted by the first TA value.
Aspect 54: The method of aspect 53, further comprising: receiving a second TA value included with the DCI, the second TA value being associated with at least one of: a candidate special cell (spCell), or a candidate cell group (CG).
Aspect 55: The method of aspect 53 or 54, wherein at least one of: the candidate spCell is a deactivated candidate spCell, or the candidate CG is a deactivated candidate CG.
Aspect 56: The method of any of aspects 53 through 55, wherein the DCI is a transmission configuration indicator (TCI) update DCI.
Aspect 57: The method of any of aspects 53 through 56, wherein the first TA value included in the DCI is applied after a predetermined number of symbols from the DCI.
Aspect 58: The method of any of aspects 53 through 57, wherein the first TA value included in the DCI is applied after a predetermined number of symbols from an acknowledgment (ACK) corresponding to the DCI.
Aspect 59: The method of any of aspects 53 through 58, wherein the DCI includes a timing advance group identifier (TAG ID).
Aspect 60: The method of any of aspects 53 through 59, wherein the DCI is a group-common DCI including one or more fields of TA values, wherein each of the one or more fields is associated with a timing advance group identifier (TAG ID).
Aspect 61: An apparatus configured for wireless communication comprising at least one means for performing a method of any one of aspects 31 through 60.
Aspect 62: A non-transitory computer-readable medium storing computer-executable code, comprising code for causing an apparatus to perform a method of any one of aspects 31 through 60.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A network entity, comprising:
a memory; and
a processor coupled to the memory, the processor being configured to:
transmit a command to trigger a timing advance (TA) update associated with one or more timing advance groups (TAGs) associated with at least one of:
a candidate special cell (spCell), or
a candidate cell group (CG); and
receive data responsive to the command.

2. The network entity of claim 1, wherein the at least one of the candidate spCell is a deactivated candidate spCell, or the candidate CG is a deactivated candidate CG, and the TA update is associated with maintenance at a user equipment of a TA value associated with at least one of the deactivated candidate spCell, or the deactivated candidate CG.

3. The network entity of claim 1, wherein the network entity corresponds to an activated cell and the at least one of: the candidate special cell (spCell), or the candidate cell group (CG) corresponds to a deactivated cell.

4. The network entity of claim 1, wherein the command is at least one of:
an spCell update command, or
a CG update command.

5. The network entity of claim 1, the processor being further configured to:
transmit a timing advance command (TAC), including the TA update associated with the one or more TAGS to a user equipment.

6-16. (canceled)

17. A user equipment, comprising:
a memory; and
a processor coupled to the memory, the processor being configured to:
receive a command to trigger a timing advance (TA) update associated with one or more timing advance groups (TAGs) associated with at least one of:
a candidate special cell (spCell), or
a candidate cell group (CG); and
transmit at least one of a reference signal or data in response to receiving the command.

18. The user equipment of claim 17, wherein the candidate spCell is a deactivated candidate spCell and the candidate CG is a deactivated candidate CG, and the TA update is associated with maintenance at the user equipment of a TA value associated with the at least one of the deactivated candidate spCell, or the deactivated candidate CG.

19. The user equipment of claim 17, wherein the command is at least one of:
an spCell update command, or
a CG update command.

20. The user equipment of claim 17, wherein the reference signal is an uplink reference signal, and the processor is further configured to:
receive an updated TA value from the at least one of: the candidate special cell (spCell), or the candidate cell group (CG) in response to transmitting the reference signal; and
store the updated TA value as a maintained TA value associated with the at least one of: the candidate special cell (spCell), or the candidate cell group (CG).

21. The user equipment of claim 17, wherein the reference signal is at least one of:
a sounding reference signal (SRS), or
a random access preamble carried by a physical random access channel (PRACH).

22. The user equipment of claim 17, wherein the data corresponds to a report of a receive (Rx) timing difference between an activated spCell associated with a network entity and the candidate spCell.

23. A user equipment, comprising:
a memory; and
a processor coupled to the memory, the processor being configured to:
receive a downlink control information (DCI) including a first timing advance (TA) value, and
transmit an uplink slot having a time of transmission adjusted by the first TA value.

24. The user equipment of claim 23, the processor being further configured to:
receive a second TA value included with the DCI, the second TA value being associated with at least one of:
a candidate special cell (spCell), or
a candidate cell group (CG).

25. The user equipment of claim 24, wherein at least one of:
the candidate spCell is a deactivated candidate spCell, or
the candidate CG is a deactivated candidate CG.

26. The user equipment of claim 23, wherein the DCI is a transmission configuration indicator (TCI) update DCI.

27. The user equipment of claim 23, wherein the first TA value included in the DCI is applied after a predetermined number of symbols from the DCI.

28. The user equipment of claim 23, wherein the first TA value included in the DCI is applied after a predetermined number of symbols from an acknowledgment (ACK) corresponding to the DCI.

29. The user equipment of claim 23, wherein the DCI includes a timing advance group identifier (TAG ID).

30. The user equipment of claim 23, wherein the DCI is a group-common DCI including one or more fields of TA values, wherein each of the one or more fields is associated with a timing advance group identifier (TAG ID).
